(19) United States
(12) Patent Application Publication
(10) Pub. No.: US 2009/0027495 A1
(43) Pub. Date: Jan. 29, 2009

(54) Internet visual surveillance and management technology for telecommunications, Internet, cellular and other communications companies

(76) Inventors: Stas Oskin, Tel-Aviv (IL); Eli Sahar, Tel Aviv (IL)

Correspondence Address: NEO IT SOLUTIONS LTD., BEIT-HILLEL 18, TEL-AVIV, 67017, IL

(21) Appl. No.: 11/782,751

(22) Filed: Jul. 25, 2007

(51) Int. Cl. H04N 7/00

(52) U.S. Cl. 348/143; 348/E07.091

(57) ABSTRACT

A visual surveillance system described enabling plurality of telecommunications, Internet, cellular and other communications companies and providers to provide commodity online surveillance services, products and values to plurality of clients comprising: plurality of serving apparatus, plurality of on-site apparatus and plurality of stationary and mobile apparatus. The serving apparatus comprising: media gateway mechanisms, analysis mechanisms, media distribution mechanisms, messages and notification mechanisms, recording mechanisms, control mechanisms, abstract database mechanisms and abstract media storage mechanisms. The visual surveillance system also comprising: distributed architecture and distributed storage file system from plurality of serving apparatus.

### CROSS-REFERENCE TO RELATED APPLICATIONS

Not applicable

### FEDERALLY SPONSORED RESEARCH

Not applicable

### BACKGROUND OF THE INVENTION

This invention relates generally to visual surveillance systems and in particular to visual surveillance system enabling telecommunications companies and Internet providers to provide commodity visual surveillance services.

The prior art surveillance technology was always developed and positioned as an on-site solution. Systems based on this technology are always requiring some sort of a central management device, in order to process the live feeds arriving from cameras. The device can be analogue or digital video recorder, or a computer with special software installed, but it always need to be present on-site, together with the cameras. When multiple sites are required to be covered with cameras, the device has to be placed on each and every site, significantly increasing the hardware costs, required maintenance and other around expenses.

Recent advancements in the video surveillance technology brought a powerful alternative to analogue surveillance systems in form of Internet-based (IP) surveillance systems. IP cameras can now be placed in any site with Internet connection, and allow remote view over the Internet. Still, a management device has to be placed in some location to collect and process feeds from these cameras. This location is usually the organization HQ or any dedicated security location.

The costs of such device are usually high, and with every new added site, are increasing geometrically. Most of such devices are coming in form of appliances which are limited to particular number of cameras. This requires a purchase of a new appliances, as the number of the sites grows, which brings the additional costs of configuration, increased maintenance and overall complications of such setup. Moreover, as most of the Internet connectivity lines are limited in bandwidth, adding more sites increases camera information throughput and requires leasing new Internet lines, which further increase the overall costs and maintenance complications.

As the device placed in particular location, the collected cameras information is limited to the users located in this site. Due to limited Internet lines, users from other locations, including the sites with placed IP cameras, are unable, or have no convenient way to access the collected information. Even if the appliance supports Internet access, the lines limits the concurrent number of users which can access the information. This makes real-time collected information sharing impossible, which is especially critical for large organization.

Also, as the device is placed in a central location with limited number of Internet lines, this location becomes a single point of failure. Any problem in the device, connectivity equipment or the infrastructure often can cause significant downtimes, unacceptable for surveillance and security needs. Moreover, any problems with the cameras or the Internet connectivity to them, can go unnoticed for a long time, and cause loss of required information in critical moments.

Additionally, due to the high costs of such setup, small business and private premises users often can not afford it. They need to use sub-optimal alternatives which include old-generation recorders or special software on computer. Such alternatives are not comfortable, and often do not provide the required functionality. The users are often unable to watch the live feeds and recorded information remotely. Even if such option exists, it often requires the users to remember his home or business IP address or purchase and setup a domain name. The users are also required to install special viewing software, which download and installation often prohibited or prevented at the location they want to view the feeds from. They are especially vulnerable to hidden camera downtimes described above as the user checks the camera only so often.

Furthermore, there is additional limitation which prevented a widespread adoption of the surveillance technology by the users. Even that the Internet changes every aspect of life and the communications are reaching everywhere; the surveillance technology keeps evolving in traditional concept of on-site systems. As all of the systems rely on limited devices, communication companies, while having the required communication infrastructure, can not provide low-cost visual surveillance services to clients, and commoditize the technology.

The IP cameras somewhat changed the situation, but the requirement of specialized devices, planned exclusively for on-site installations, still prevents the communication companies from granting these services. This keeps the technology out of reach of general public, without regards to it of being the most effective business and personal premises security measure available.

Accordingly, there has been a long felt need for visual surveillance and management technology, which will solve the described limitations, and allow the telecommunication companies and Internet providers to start providing visual surveillance services, making the surveillance technology available to the general public.

### DESCRIPTION OF PRIOR ART

U.S. Pat. No. 6,385,772 Monitoring system having wireless remote viewing and control Courtney; Jonathan D. Courtney; Jonathan D. Texas Instruments Incorporated (Dallas, Tex.) application Ser. No. 09/292,501
U.S. Pat. No. 6,542,191 Image display apparatus, camera control apparatus and method Yonezawa; Hiroki Yonezawa; Hiroki Canon Kabushiki Kaisha (Tokyo, JP) application Ser. No. 08/839,828
U.S. Pat. No. 6,556,241 Remote-controlled camera-picture broadcast system Yoshimura; Naoto, Ohno; Hideo, Okano; Hisashi Yoshimura; Naoto, Ohno; Hideo, Okano; Hisashi NEC Corporation (Tokyo, JP) application Ser. No. 09/124,909
U.S. Pat. No. 6,608,649 Camera system, control method, communication terminal, and program storage media, for selectively authorizing remote map display using map listing Suzuki; Kazuko, Kawai; Tomoaki Suzuki; Kazuko, Kawai; Tomoaki Canon Kabushiki Kaisha (Tokyo, JP) application Ser. No. 08/950,743
U.S. Pat. No. 6,675,386 Apparatus for video access and control over computer network, including image correction Hendricks; John S., McCoskey; John S., Asmussen; Michael Hendricks; John S., McCoskey; John S., Asmussen; Michael Discovery Communications, Inc. (Silver Spring, Md.) application Ser. No. 08/923,091
U.S. Pat. No. 6,698,021 System and method for remote control of surveillance devices Amini; Shaun S., Backlund; Gary Amini; Shaun S., Backlund; Gary Vigilos, Inc. (Seattle, Wash.) application Ser. No. 09/417,162
U.S. Pat. No. 7,124,427 Method and apparatus for surveillance using an image server Esbensen; Daniel Esbensen; Daniel Touch Technologies, Inc. (San Diego, Calif.) application Ser. No. 09/482,181
U.S. Pat. No. 7,133,065 System and method for selectively providing video of travel destinations McEneany; Ian P McEneany; Ian P

### SUMMARY OF THE INVENTION

In accordance with the present invention there is provided a visual surveillance system comprising an Internet, a plurality of surveillance and communications equipment connected to the Internet, plurality of servers in plurality of datacenters connected to the Internet, plurality of clients connected to the Internet via plurality of devices as personal computers, PDA's, mobile phones, and wireless-enabled laptops. The servers in datacenter consist from plurality of media gateway servers, analysis servers, media distribution servers, messages and notification servers, recording servers, control servers, abstract database, and abstract media storage.

The visual surveillance system of the present invention provides a visual surveillance system which the telecommunication companies and Internet providers can offer to their clients as a service. The telecommunication companies begin by installing the surveillance and communication devices in the client sites. Further, the telecommunication companies and Internet providers also set up infrastructure in their data centers to receive and store surveillance data from the client sites and provide the service to the clients. The communication companies and Internet providers can further create agreements with cellular providers to integrate cellular phones into the system.

The infrastructure in data center includes media gateway servers and analysis servers, which can be organized in distributed structure built from plurality of low-cost servers, connected between them and to the Internet. The distributed structure is organized in the following three layers: connection layer, decoding layer and analysis layer. Each layer performs various operations on the incoming surveillance data, which moves through it in vertical fashion. Each layer is fully redundant before other layers, and can withstand failures from multiple servers. The data is redirected from failed servers to the operational ones, until the completion of the required operations in the relevant layer, before passing to the next one.

The abstract media storage can consist from plurality of low-cost servers, connected between them and to the Internet. The servers have two main roles: control servers and recording servers. The control servers instruct the recording servers with the operations the recording servers needs to do with the incoming media. Both the roles are fully redundant between them, and can withstand multiple server failures. The stored data is redirected from failed control and recording servers to the operating ones until a successful and reliable storage of the data is complete. The control servers can also copy, move and synchronize the stored media between the recording servers, in order to optimize the data distribution. The control servers can also pass the surveillance media requests to the recording servers, so these would supply the requested surveillance media directly to the client devices, preventing the load on the control servers.

The visual surveillance system of the present invention also provides a web oriented interface to the clients, built with web and media technologies, including but not limited to AJAX, DHTML, Microsoft Windows Media, Apple QuickTime, and Adobe Flash. This allows the clients to access the surveillance media without the need to install any software or applet like ActiveX or any other downloadable and installable applications. The media technologies are using the native player already installed on the client computer to deliver the surveillance media. If no native player is installed, native run-time platforms, including but not limited to Java, NET or Silverlight, are used to run applet players that do not require installations, and which play the surveillance media.

The web oriented interface supports the presentation of plurality of surveillance sources, control of the surveillance devices, and playback of the stored media in a convenient matter.

The interface also supports presentation of the surveillance data coming from plurality of surveillance sources according to profiles, thus granting only the necessary view and control options to the relevant clients. This allows a separation of authority and different levels of roles and permissions between different clients. This is in turn contributing to the increased confidentiality and security of the surveillance data.

The interface also provides a mobile version of itself, for convenient operations on mobile devices with limited presentation abilities. This enables the client to perform complex operation from anywhere with the same convenience as from a personal computer featuring increased presentation abilities.

The interface allows accessing various infrastructure servers, as the media distribution, recording and storage, or notifications through a single point of view and control, both from personal computers and mobile devices. This allows a convenient operation of the entire system and its functionalities across various client devices.

The interface also allows the client to control plurality of servers through a single point of view and control, presenting the entire experience as working with a single server. This enables the client to control plurality of surveillance devices in plurality of client sites, through plurality of servers with the same simplicity as working with a single surveillance device in single client site, and with single server, reducing complications and increasing the convenience.

The visual surveillance system of the present invention also provides a system supporting a plurality of devices in plurality of client sites, and plurality of connecting clients. The system can grow and expand from a single server to an unlimited number of servers, supporting growing number of client sites and growing number of connecting clients. Plurality of clients can connect to the system, view and operate live and stored surveillance data, and control plurality of surveillance devices.

The visual surveillance system of the present invention also provides a system able to notify mobile devices with email, short text and multimedia messages. The messages can contain plain text, surveillance data snapshots, or surveillance media segments for mobile viewing on the devices.

The visual surveillance system of the present invention also provides a system supporting a plurality of types of surveillance devices, and plurality of types of client devices. The media gateway and distribution mechanisms detect the used surveillance devices and the client devices, and initiate the appropriate procedures to correctly capture, process and present the surveillance data.

The visual surveillance system of the present invention also provides a unified media format, especially optimized for storage on centralized servers. The gathered surveillance data is converted into the unified media format, and stored on the abstract surveillance data storage. When the stored surveillance data is required, it is converted into the appropriate surveillance media format that can be played by client devices, and distributed to plurality of client devices.

The visual surveillance system of the present invention also provides a system where the servers can be alerted by the surveillance device regarding any activity. Only then the servers begin to process the data. This saves the server resources and allows serving more clients.

The visual surveillance system of the present invention also provides a system that can perform self-diagnostics and diagnose the infrastructures it relies upon. In the event of any malfunction, shortage or disconnection, relevant parties can be notified to resolve the issues and ensure a minimum downtime, thus granting a maximum availability.

The visual surveillance system of the present invention also provides the following additional advantages: one advantage is that the clients no longer required to purchase expensive on site recording devices. The client site needs only a surveillance and communication device. Another advantage is that clients able to view the surveillance media, and control the surveillance devices, with any device connected to the Internet. Another advantage is that the gathered surveillance data is analyzed by centralized servers, allowing centralized deployment and upgrade of analysis modules and procedures. Another advantage is that all the surveillance data is stored in centralized data centers, secured both logically and physically, keeping the surveillance data safe from physical and nature threats. Another advantage is that the stored surveillance data is available to plurality of clients anywhere in the world. Another advantage is that that the surveillance data can be easily shared between pluralities of interested parties for business usage and needs. Another advantage is that plurality of clients can watch high-quality surveillance data regardless the available bandwidth connection on the client sites, as the surveillance data from plurality of surveillance devices is broadcasted, for business usage and needs. Another advantage is that the whole visual surveillance system is delivered and used from a web browser.

Other advantages and applications of the present invention will be made apparent by the following detailed description of the preferred embodiment of the invention.

### BRIEF DESCRIPTION OF THE SEVERAL VIEWS OF THE DRAWINGS

FIG. 1—a schematic view of the invention

FIG. 2—a schematic view of the server topology in the datacenter

FIG. 3—a schematic view of the media distribution to plurality of users via streaming server

FIG. 4—a schematic view of notifications to mobile phones

FIG. 5—a diagram of streaming server with adaptive media distribution to different devices

FIG. 6—a schematic view of plurality of cameras Pan/Tilt/Zoom (PTZ) control via centralized server

FIG. 7—a schematic view of connectivity gateway supporting plurality of brands of cameras

FIG. 8—a diagram of connectivity gateway and unified format conversion process

FIG. 9—a diagram of bridging between operation systems from different vendors and types, and conversion of unified media to native media using unified media protocol

FIG. 10—a diagram of bridging between operation systems from different vendors and types, and conversion of unified media to native media using inter-process communications

FIG. 11—an alternative embodiment of FIG. 10 with the conversion of unified media format to native media format performed on the distribution server side

FIG. 12—a schematic view of distributed infrastructure architecture based on three or more role layers, composed from plurality of commodity servers

FIG. 13—a schematic view of distributed file system (DFS) composed from plurality of commodity servers

FIG. 14—a schematic view of distributed file system (DFS) distributing the events copies in order to maintain an acceptable number of events copies

FIG. 15—an alternative embodiment of FIG. 14 with the direct events copies distribution

FIG. 16—schematic view of distributed file system (DFS) 38 serving the requests for stored events in unified media format

FIG. 17—a diagram of live view and control web interface mode

FIG. 18—a diagram of playback view and media download web interface mode

FIG. 19—a diagram of surveillance matrix mode with plurality of surveillance feeds

FIG. 20—a diagram of camera initiated analysis and notifications

FIG. 21—a diagram of alternative embodiment to FIG. 20 with cameras setting special flags in surveillance data

FIG. 22—a diagram of 3^{rd} and higher generation mobile phone video operations and control

FIG. 23—a diagram of installed player detection and fallback to platform technology

FIG. 24—a schematic view presenting surveillance media and stored events from plurality of sites in a unified way

### BRIEF DESCRIPTION OF THE SEVERAL REFERENCE NUMBERS IN THE VIEWS OF THE DRAWINGS

1—wireless camera
2—wired camera
3—wireless access point or wireless router
4—wired router
5—the Internet
6—secure data center, located at ISP or Telco
601-60n—plurality of servers for invention operations in the secure data center
7—user premises, home or office
701-70n—plurality of computers in user premises
8—wireless Personal Assistant Device (PDA) or wireless palmtop
9—mobile phone
10—wireless laptop
11—invention analysis server
12—invention recording server
13—invention messages and notifications server
14—invention media distribution server
15—events information database
16—events media storage
18—invention camera media gateway server
19—invention command and control server
81-8n—plurality of PDA's
91-9n—plurality of mobile phones
101-10n—plurality of laptops
17—cellular provider
20—invention media distribution server unit
21—user device, OS vendor and compatible format detector
221-22n—plurality of native media distribution sources
231-232—plurality of computers with operation systems from different types and vendors
201-20n—plurality of cameras
240-24n—plurality of cameras with different media formats from different vendors, types and models
24—invention media gateway server unit
25—camera type, vendor, model, compatible protocol and format detector
261-26n—plurality of camera protocol connectors
271-27n—plurality of camera format decoders
28—unified media format output
29—unified media format source
30—unified protocol output unit
300—shared memory unit
301—shared memory pool
302—inter-process communication server
303—inter-process communication client
31—native format encoder
32—unified protocol server
33—native format broadcasting unit
330—unified protocol client
331—native format broadcast server
34—user devices
351-35n—plurality of camera gateway servers in distributed architecture
361-36n—plurality of unified format conversion servers in distributed architecture
371-37n—plurality of analysis servers in distributed architecture
38—distributed file system (DFS)
391-39n—plurality of DFS controller servers
401-40n—plurality of DFS recording and storage servers
41—geographic map
42—geographic locations
43—video display
44—operation mode switch
45—cameras PTZ controls
46—aid and utility links section
461—context sensitive controls
47—Internet browser window
48—maximize and minimize controls
49—events diary
50—events hourly map
51—events playback controls
52—events media download
53—surveillance display matrix
90—3rd and higher generation mobile phone
121-12n—plurality of media recording servers
141-14n—plurality of media broadcasting servers
191-19n—plurality of command and control servers
115—invention central presentation and control server
117—surveillance data circular buffer

### DETAILED DESCRIPTION OF THE INVENTION

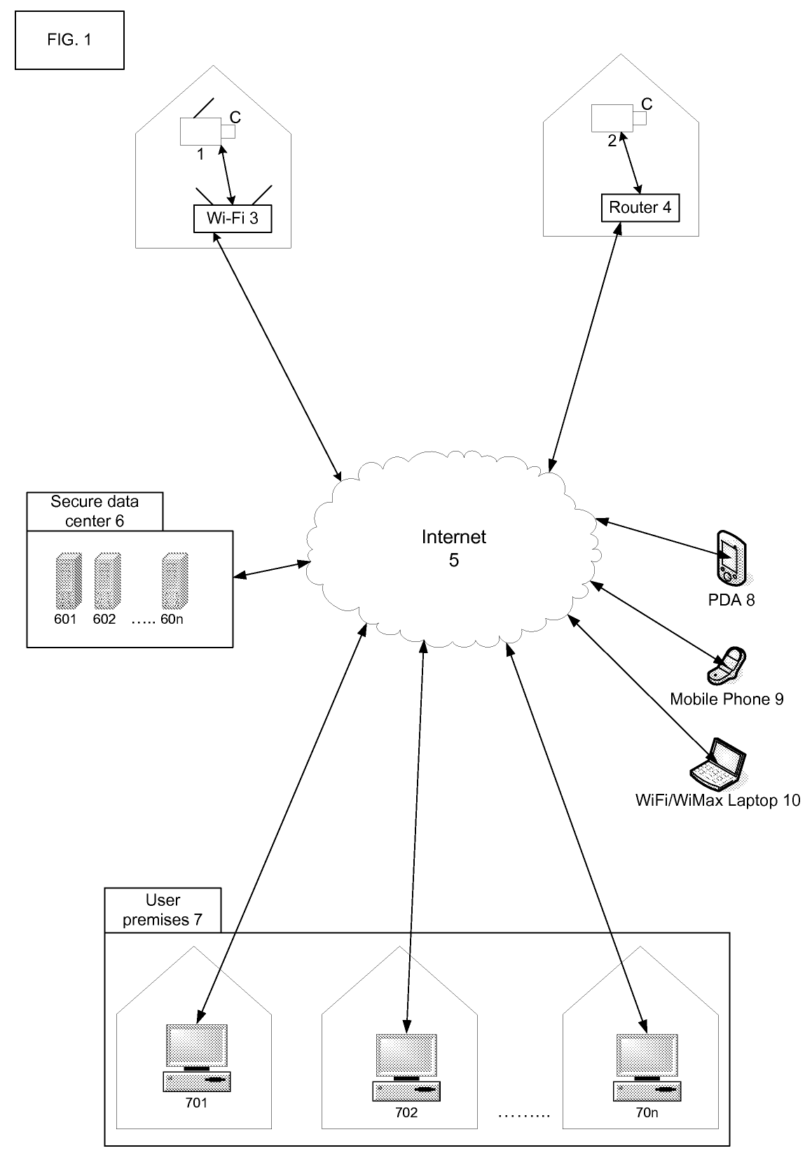

FIG. 1 shows a schematic view of the invention as it being deployed geographically. Wireless cameras 1 and wired cameras 2 are installed in user sites. The cameras 1 and 2 are connected to wireless router 3 or wired router 4, which in turn connected to the Internet 5.

In a remote, secure data center 6, there is a plurality of servers 601 to 60n running the invention technology in order to perform invention operations. The data center 6 is connected to the Internet 5, and enables the servers to connect to cameras 1 and 2 through routers 3 and 4, in order to gather the surveillance data.

PDA 8, mobile phone 9 and WiFI/WiMax 10 laptops connect to the servers 601-60n in secure data center 6, over the Internet 5, and allow the mobile users to perform plurality of invention operations. For example, the users can view and control the cameras 1 and 2 via their PDA 8, mobile phone 9 and laptop 10, replay recorded media on these devices, receive email notifications and more. Additionally, users with mobile phones 9 can receive SMS (short message service) or MMS (multimedia message service) message notifications.

Plurality of computers 701-70n in user premises 7 connect to the servers 601-60n in secure data center 6, over the Internet 5, and allow the users to perform invention operations. The operations may be similar to the described above, or may include additional functionalities, due to computers 701-70n extended presentation and control capabilities.

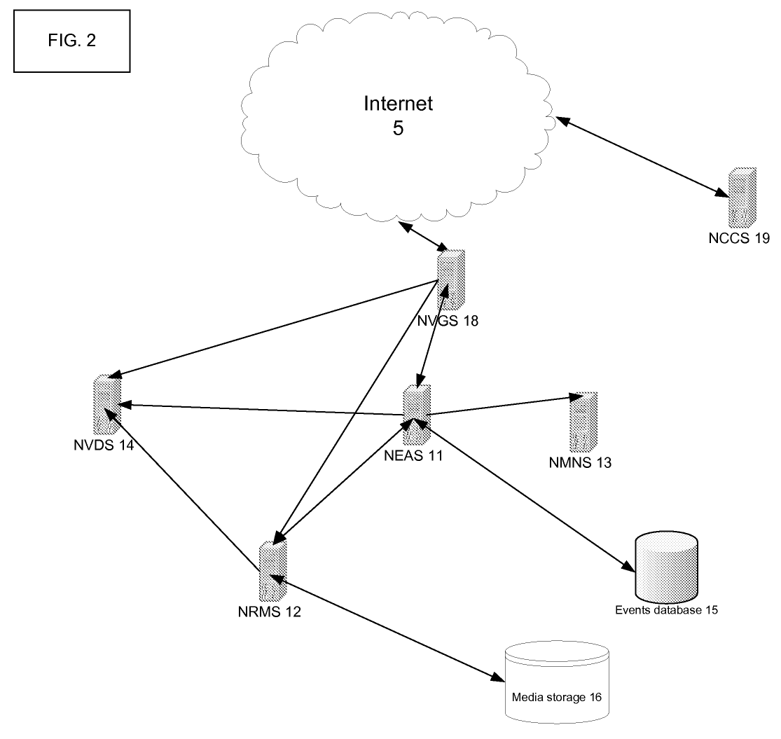

FIG. 2 shows a schematic view of servers 601 to 60n roles in the secure datacenter 7. The command and control server 19 connects to cameras and other devices over the Internet 5, and enables the users to perform plurality of functions on them. For example, the users can move the cameras, rotate them and change their zoom and focus. The command and control server 19 keeps track of the functionality provided by the cameras and devices, and translates user commands into format and type supported by the cameras and devices for maximum compatibility.

The media gateway server 18 connects over the Internet 5 to plurality of cameras of different types, models and which are made by different vendors. The gateway server 18 interfaces with plurality of protocols, formats and codecs native to different cameras and devices, and retrieves the surveillance data from them. The gateway server 18 then converts the retrieved surveillance data into a unified media format for future invention operations. Additionally, the gateway server 18 may perform plurality of operations during connectivity to cameras and devices, and during the media conversion process. For example, the gateway server 18 may shape bandwidths of several cameras or devices sharing the same Internet connection, and give more available bandwidth to particular camera or device.

The analysis server 11 performs plurality of operations on the unified media format received from the gateway server 18. For example, the analysis server 11 can perform motion detection operations to detect events, recognize perimeter breaches, recognize faces and recognize abandoned objects. The analysis server 11 stores rules describing how to perform the operations, and which actions to perform upon the operations results. For example, in case of motion detection, and according to predefined schedule, the analysis server may choose to notify a predefined contact personal about the event, and record the event to media.

The analysis server 11 may send signals to the gateway server 18 instructing it to change the methods it uses to gather surveillance data from the cameras and converting it to the unified media format. For example, the analysis server 11 may instruct the gateway server 18 to give higher bandwidth priority to particular camera, if the surveillance data coming from it contains topics of interest for the analysis server 11.

The analysis server 11 stores records with events, operations results and performed actions descriptions in events information database 15. For example, one such record may contain the date and time of the event, event location, a number of snapshots from the event, the reason behind event (i.e. motion, abandoned object) and the taken action, like the sent notification and its destination. If the event surveillance data was recorded, the record will also contain the identifier of the created media.

The messages and notifications server 13 performs communication with users, by sending notifications or messages to their devices. The messages and notifications server 13 keeps track of user devices capabilities, and sends the notifications or messages in a format and type supported by the devices for maximum compatibility.

The messages and notifications are sent according to signals the messages and notifications server 13 receives from the analysis server 11.

The recording server 12 receives surveillance data in unified media format from gateway server 18; or events in unified media format from the analysis server 11 and stores them in unified media format on media storage 16. The media storage 16 could be for example hard drive, network attached storage, magnetic tape or any other commodity device providing long term reliable physical media storage.

The recording server 12 also serves the stored media on-demand, by retrieving the stored media from media storage 16 according to signals it receives from the distribution server 14 and from the analysis server 11, and then serving the retrieved media to these servers.

The distribution server 14 distributes surveillance data and stored events to plurality of users, in real-time or on-demand, by retrieving the media in unified media format from gateway server 18, analysis server 11 or recording server 12, and converting it into a distributable media. The distribution server 14 then distributes the converted distributable media to user devices by streaming, broadcasting, progressive downloading or other means. The distribution server 14 recognizes the connected user devices, and specifically converts the distributable media to be natively supported by the user devices for maximum compatibility. The distribution server 14 may also distribute media when notified by the analysis server 11. For example if an event was detected by the analysis server 11, it may instruct the distribution server 14 to begin distributing the event to all the connected users.

It's important to notice that there can be a plurality of servers described above, of the same or different invention server role, in the secure data center 6 of ISP or Telco. Not all server roles have to be in the same secure datacenter 6, and they can be distributed in a plurality of secure datacenters 6, having the invention servers communicate between themselves via secure Internet lines.

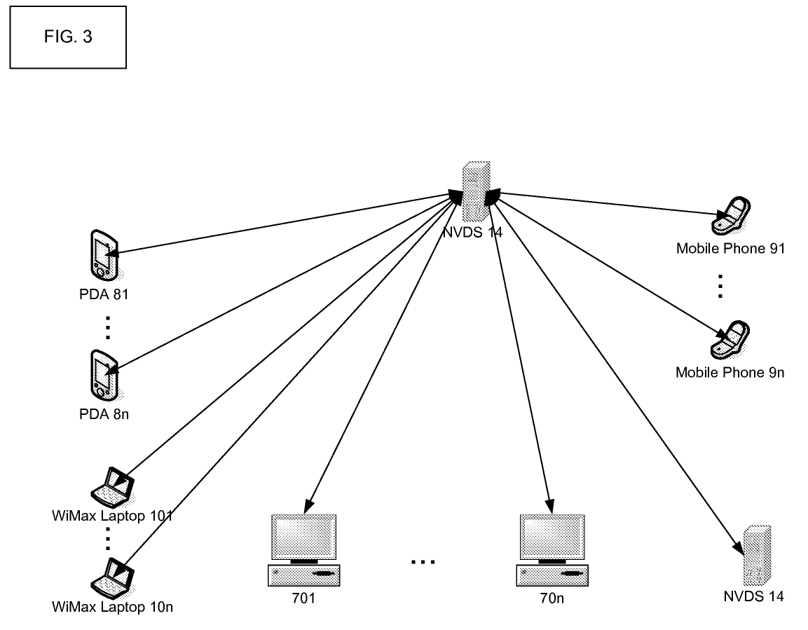

FIG. 3 shows a schematic view of distribution server 14 which distributes surveillance media to plurality of user devices. These client devices may include, but not limited to, personal assistant devices (PDA) 80-8n, WiFi/WiMax enabled laptops 10n-101, mobile phones 91-9n, and personal computers 701-70n. The user devices connect with requests for surveillance media to distribution server 14, which registers the connected device. The distribution server 14 then distributes the surveillance media in format supported by these devices for maximum compatibility.

A single distribution server 14 may distribute media to a theoretically unlimited number of user devices. Additionally, the distribution server 14 may forward surveillance media to plurality of other distribution servers 14, which may in turn distribute the surveillance media to plurality of user devices, or forward the surveillance media to plurality of additional distribution servers 14 again, creating a scalable structure able to distribute surveillance media to unlimited number of user devices.

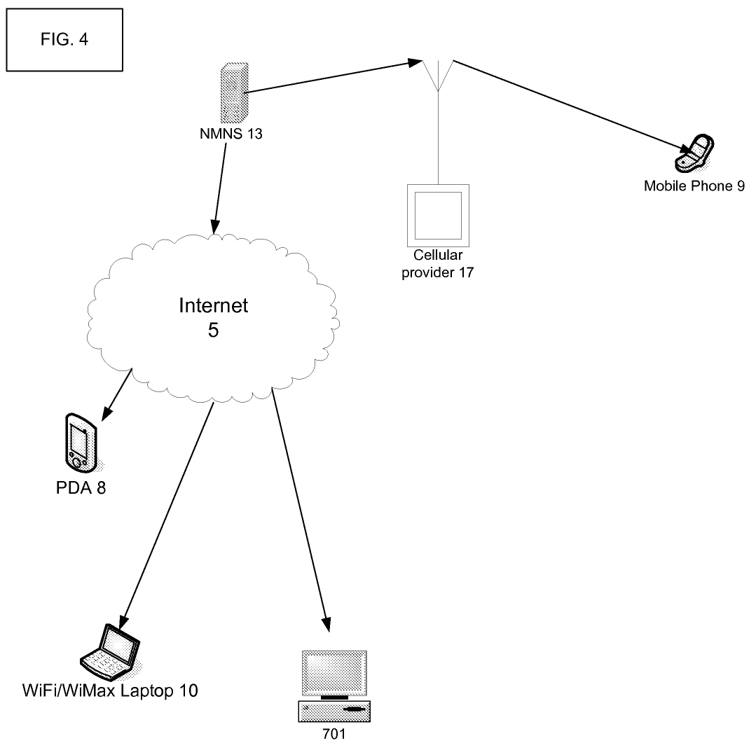

FIG. 4 shows schematic view of messages and notifications server 13 operation, which sends notifications or messages to plurality of users devices. The messages and notifications server 13 keep track of the target devices and their presentation abilities, and sends the specific notification or message type supported by the target device. For example, the messages and notification server 13 may send short text messages to basic mobile phones 9, multimedia messages to multimedia enabled mobile phones 9, and emails to smart-phones 9, PDA 8, laptops 10 and personal computers 701.

The messages and notification server 13 may use cellular provider 17 to send messages and notifications to cellular device 9 over-the-air. The messages and notifications server 13 may also use the Internet 5 for devices with Internet access, like PDA 8, laptops 10 and personal computers 701.

The messages and notifications sent may contain a surveillance media allowing playing it back on the target device, or alternatively a link to surveillance media, which accessible via the distribution server 14. In this case the target device will be able to contact the distribution server 14 and request the surveillance media via the media link.

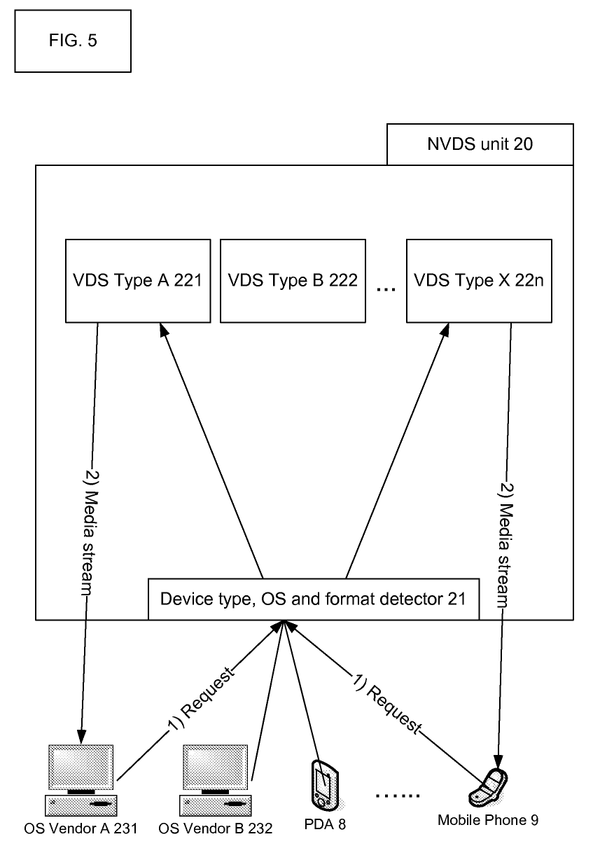

FIG. 5 shows a diagram of media distribution server unit 20, which the software part in media distribution server 14, and interacts with plurality of user devices. The user devices for example, may include but not limited to, personal computers 231 and 232 from different OS types and vendors each, PDA's 8 and mobile phones 9.

Each user device initiates a surveillance media request to the distribution server 14. The distribution server 14 passes the request to user device, OS vendor and compatible format type detector 21, which analyzes the device type, OS installed on the device and the media format supported by the device. Then the detector 21 finds a suitable media source from the plurality of native media distribution sources 221-22n running on the distribution server 14. The suitable media source should have maximum compatibility with the requesting device. Then the detector 21 forwards the surveillance media request to the suitable media source, which in turn serves the requesting device with the surveillance media.

For example, a surveillance media request coming from standard personal computer with Windows OS and a default Windows Media Player installed, may be classified by the detector 21 as belonging to the class of Windows Media, and be forwarded to Windows Media Services media source, with the instruction to serve WMV (Windows Media Video) format. Alternatively, a request coming from Apple Macintosh may be classified by the detector 21 as belonging to the class of Apple QuickTime, and be forwarded to QuickTime Streaming Server media source with the instruction to serve MPEG4 format.

Alternatively, a request coming from mobile handset may be classified by the detector 21 as belonging to the class of 3 mobile phones generation, and be forwarded to QuickTime Streaming Server media source with the instruction to serve 3 GP or MPEG4 format.

This operation is performed transparently for the user device, which always receives the media in compatible format it can display to the user.

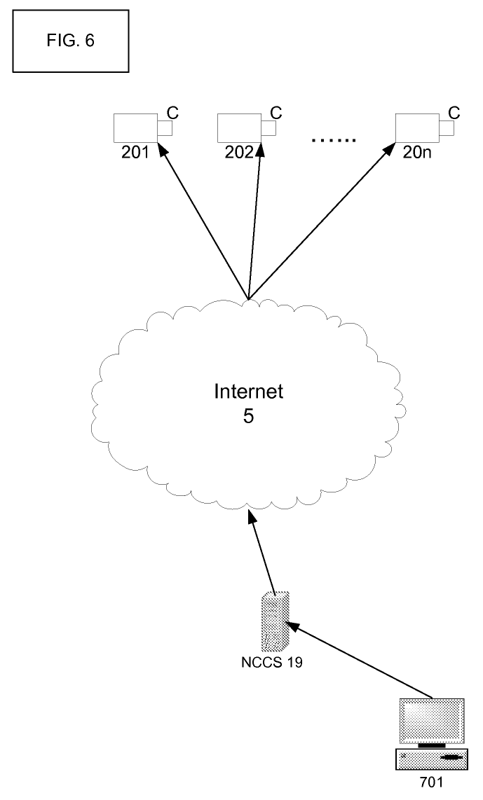

FIG. 6 shows a schematic view of control and command server 19 which allows a remote control of plurality of cameras 201-202, each from a different vendor, type or model, over the Internet 5. Users connect to the control and command server 19 from their personal computer 701, select required cameras from plurality of cameras 201-202, and submit variety of commands to perform. For example, the user may submit the commands that move the cameras, rotate them or change their zoom and focus.

The control and command server 19 keeps track of the cameras vendors, type or models, and their supported capabilities and application interfaces. The control and command server 19 translates the submitted user commands, adapting the commands to different control protocols and interfaces supported by each camera, bridging over the vendors, types and models differences.

Commands which are not supported by the plurality of cameras 201-202, can be emulated by the control server 19 to a reasonable degree. For example, if the camera does not support zoom or focusing, the control server 19 may request the gateway server 18 to scale or shrink the received surveillance data video in order to emulate the requested effect.

This operation is performed transparently before the user allowing the control of plurality of cameras 201-202 via a generic set of commands.

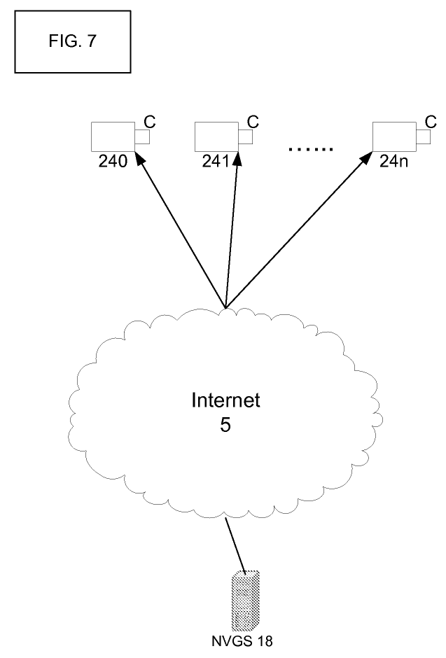

FIG. 7 shows a schematic view of camera media gateway server 18 which connects to plurality of cameras 201-202, each from a different vendor, type and model, over the Internet 5. The camera media gateway server 18 recognizes the camera vendor, the software installed on camera, the protocols and formats supported by the camera. The camera media gateway server 18 connects then to the camera using the protocol and format best under the circumstances. The camera media gateway server 18 begins then to retrieve the surveillance data, and convert it to the unified media format for further invention operations.

For example, the camera media gateway server 18 when attempting to connect to Vivotek MPEG 4 cameras, may classify these cameras as Vivotek brand, and may use Vivotek MPEG4 software libraries to connect to the cameras. The camera media gateway server 18 may also attempt using the UDP protocol in order to retrieve the highest quality surveillance data possible. If the UDP protocol not operational due to network conditions as firewalls or NAT devices, the camera media gateway server 18 may fallback to the TCP protocol and finally to the HTTP protocol.

This allows a transparent connection via the Internet to 5 to plurality of cameras 201-20n, regardless of their vendor, type or model, or the network conditions.

The camera media gateway server 18 may also perform plurality of operations on the retrieved surveillance data, and on the network connections to the cameras. For example, the camera media gateway server 18 may scale or shrink the retrieved surveillance data video according to signals received from other invention servers.

Also, for example, if multiple cameras on the same end-site share same physical Internet connection, the camera media gateway server 18 may give more bandwidth to a particular single camera connection and limit the bandwidth of the rest of the cameras connections, in order to retrieve higher quality surveillance data from the particular single camera.

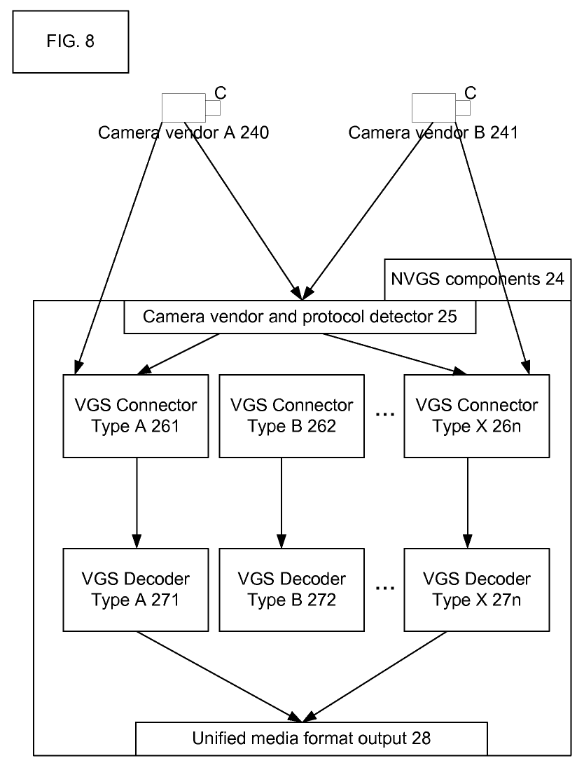

FIG. 8 shows a diagram of media gateway server unit 24 which is a software part in camera media gateway server 18, and interacts with plurality of cameras from different vendors, models and types. Cameras 240 and 241 were manufactured by different vendors, have different hardware and software components, and support different protocols and formats.

The camera media gateway server 18 passes the address and login credentials of the camera to camera type, vendor, model, compatible protocol and format detector 25. The detector 25 performs an initial connection to the camera, and analyzes its vendor, model, type and supported protocols and formats. The detector 25 then finds a suitable camera protocol connector and format decoder from the plurality of camera protocol connectors 261-26n and the plurality of camera format decoders 271-27n deployed on the camera media gateway server 18. The suitable camera protocol connector and format decoder should have maximum compatibility with the camera. Then the detector 25 forwards the camera address and login credentials to suitable camera protocol connector, which connects to the camera and begins retrieving the surveillance data. The suitable camera protocol connector then forwards the retrieved surveillance data to suitable camera format decoder, which decodes the surveillance data and delivers it to the unified media format output 28. The unified media format output 28 encodes then the decoded surveillance data into the unified media format and delivers it to the invention servers.

For example, the camera media gateway server 18 may pass the address and login credentials of Vivotek dual-codec MPEG4/MJPEG camera to the detector 25, which may classify it as Vivotek brand camera, that supports MPEG4 and MJPEG formats, and supports TCP, UDP and HTTP connection protocols. The detector 25 will then choose the UDP camera protocol connector and MPEG4 camera format decoder as the most suitable ones. If, for any reason, the suitable protocol connector unable to connect to the camera, the detector 25 may failover to the next most suitable protocol TCP, if it will not be able to connect to the cameras as well, the detector 25 may failover to the HTTP protocol. Similar process may happen with the camera format decoder, where in case of MPEG4 format decoding failure the detector 25 may failover to MJPEG format.

This enables the camera media gateway server 18 to connect to plurality of cameras regardless of their vendor, model and type, and provide unified media format to rest of the invention servers in complete transparency.

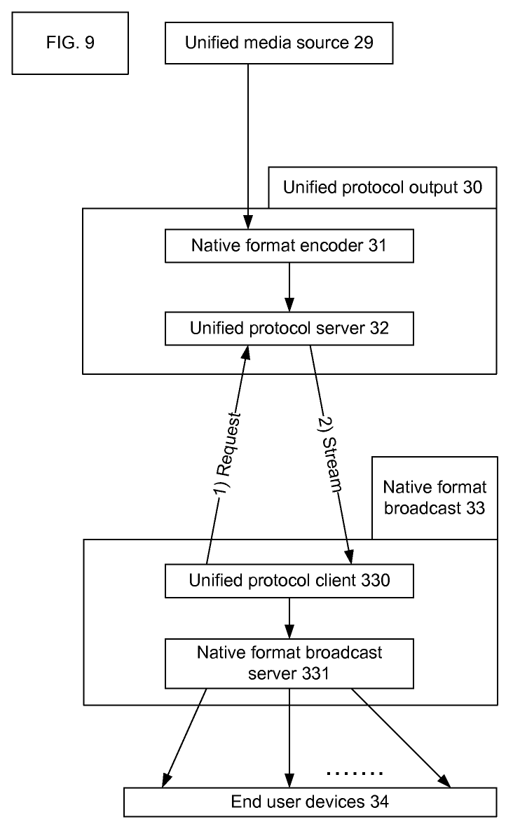

FIG. 9 shows the diagrams of unified protocol unit 30 which is the software part of invention servers, and native format broadcasting unit 33 which is the software part of media distribution server 20. The media distribution server 20 and the invention servers are running on operation systems from different types and vendors, and use the unified protocol unit 30 and native format broadcasting unit 33 to bridge between their operation systems, convert the unified media format to native media format supported by the user device and broadcast the native media to plurality of user devices 34.

The unified media format source 29 delivers unified media to native format encoder 31, which converts the unified media to the native media supported by the target user device. The native format encoder 31 then delivers the native media to unified protocol server 32, which serves requests for native media to plurality of unified protocol clients 330.

The unified protocol client 330 is a software part of native format broadcast unit 33, which is itself a software part of media distribution server 20 running on operation system from a different vendor. The unified protocol client 330 is finding, requesting for and retrieving the native media from the correct unified protocol server 32, and forwards the native media to native format broadcast server 331, which distributes the native media to plurality of user devices 34.

It's important to clarify that the process of retrieving unified media, converting it to native media, bridging over different operation systems, and distributing to the plurality of user devices is performed on-demand of the user devices.

The user devices 34 request the native media from native format broadcast server 331, which in turn forwards the request to unified protocol client 330, which in turn forwards the request over unified protocol to unified protocol server 32, which in turn forwards the request to native format encoder 31, which in turn begins retrieving the unified format media from unified media source 29.

For example, a Windows Media compatible device may request surveillance media from native format broadcast server 331 running on Windows OS, such as Windows Media Services. In case the requested surveillance media is available only on Linux OS servers, the Windows Media Services may not be able to access it and will require a bridge. The Windows Media Services then will forward the media request to unified protocol client 330 running also on Windows OS. The unified protocol client 330 will locate the correct unified protocol server 32 running on Linux OS, and will forward the media request to it over a unified protocol, such as RTP/RTSP.

The unified protocol server 32 will then forward the surveillance media request to native format encoder 31, which will retrieve the unified media from unified media format source 29 and will convert it to Windows Media.

Then the format encoder 31 will deliver the Windows Media to unified protocol server 32, which will forward the Windows Media to unified protocol client 330 on Windows OS over a unified protocol. The unified protocol client 330 will then forward the Windows Media to Windows Media Services, which will distribute the Windows Media to Windows Media compatible device.

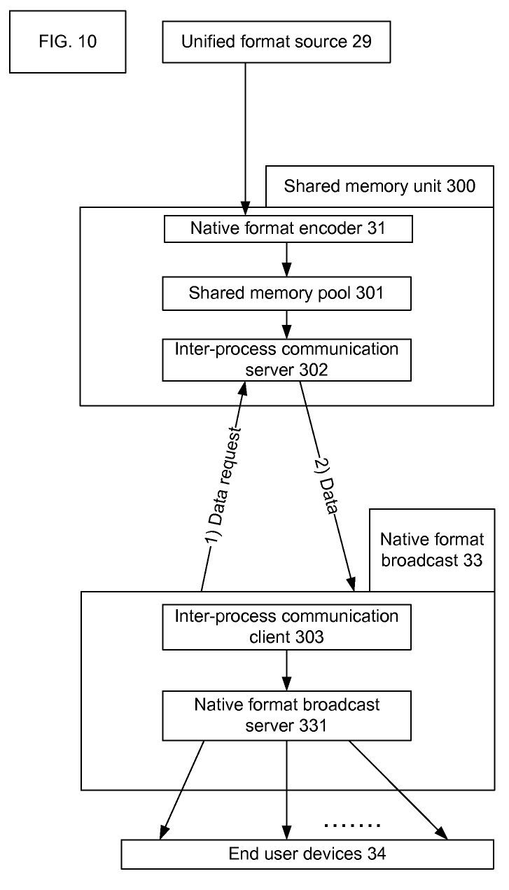

FIG. 10 shows the diagrams of shared memory unit 300 which is the software part of invention servers, and native format broadcasting unit 33 which is the software part of media distribution server 20. The media distribution server 20 and the invention servers are running on operation systems from different types and vendors, and use the shared memory unit 300 and native format broadcasting unit 33 to bridge between their operation systems, convert the unified media format to native media format supported by the user device and broadcast the native media to plurality of user devices 34.

The unified media format source 29 delivers unified media to native format encoder 31, which converts the unified media to the native media supported by the target user device. The native format encoder 31 then delivers the native media into the shared memory pool 301, which is accessed by inter-process communication server 302, which serves requests for native media to plurality of inter-process communication clients 303.

The inter-process communication client 303 is a software part of native format broadcast unit 33, which is itself a software part of media distribution server 20. The inter-process communication client 303 is finding, requesting for and retrieving the native media from the correct inter-process communication server 302, and forwards the native media to native format broadcast server 331, which distributes the native media to plurality of user devices 34.

It's important to clarify that the process of retrieving unified media, converting it to native media, bridging over different operation systems, and distributing to the plurality of user devices is performed on-demand of the user devices.

The user devices 34 request the native media from native format broadcast server 331, which in turn forwards the request to inter-process communication client 303, which in turn connects over inter-process protocol to inter-process communication server 302, which in turn forwards the request to native format encoder 31, which in turn begins retrieving the unified format media from unified media source 29.

For example, a Windows Media compatible device may request surveillance media from native format broadcast server 331 running on Windows OS, such as Windows Media Services. In case the requested surveillance media is available only on Linux OS servers, the Windows Media Services may not be able to access it and will require a bridge. The Windows Media Services then will forward the media request to inter-process communication client 303 running also on Windows OS. The inter-process communication client 303 will locate the correct inter-process communication server 302 running on Linux OS, and will forward the media request to it over an inter-process protocol, such as CORBA.

The inter-process communication server 302 will then forward the surveillance media request to native format encoder 31, which will retrieve the unified media from unified media format source 29 and will convert it to Windows Media format.

Then the format encoder 31 will deliver the Windows Media into the shared memory pool 301, which is accessed by inter-process communication server 302, which will forward the Windows Media back to inter-process communication client 303 on Windows OS over an inter-process protocol. The inter-process communication client 303 will then forward the Windows Media to Windows Media Services, which will distribute the media to Windows Media compatible device.

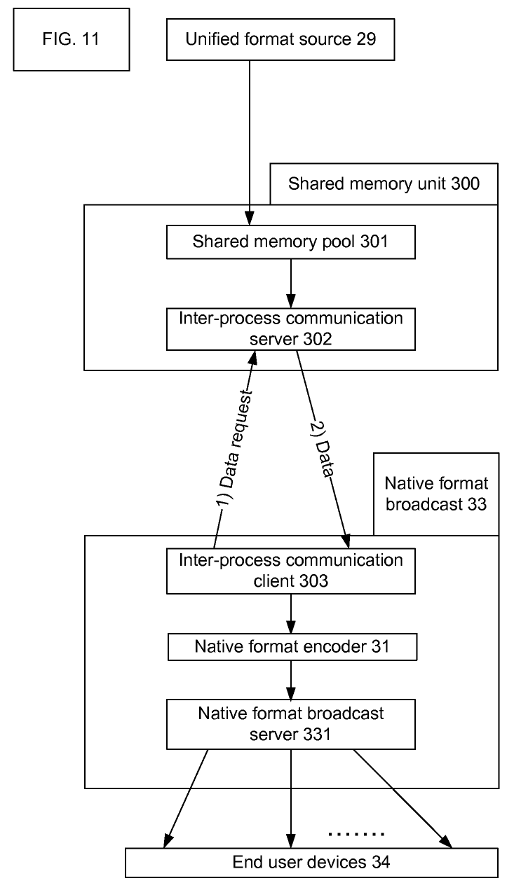

FIG. 11 shows an alternative embodiment for FIG. 10, where the native format encoder 31 is a software part of the native format broadcast unit 33.

The unified format source 29 delivers the unified media into shared memory pool 301, which is accessed by inter-process communication server 302, which serves the unified media to plurality of inter-process communication clients 303 over inter-process protocol. The inter-process communication client 303 then forwards unified media to native format encoder 31, which converts the unified media to native device media format and delivers the native media to native protocol broadcast server 331, which then forwards the native media to plurality of end users devices 34.

The advantage of this embodiment is that it allows reducing the resource usage on shared memory unit 300, by performing the CPU-intensive format conversion on the native format broadcast unit 33. As there is a plurality of broadcast units 33 that may connect to a single shared memory unit 300, this embodiment significantly increases the maximum number of broadcast units 33 the shared memory unit 300 can serve.

For example, the unified format source 29 may deliver a unified media format to shared memory pool 301, which will be accessed by inter-process communication server 302, running on Linux OS. The inter-process communication server 302 will forward the unified media over an inter-process protocol, such as CORBA, to inter-process communication client 303 running on Windows OS. The inter-process communication client 303 will forward the unified media to native format encoder 31, such as Windows Media Encoder. The Windows Media Encoder which will encode the unified media to Windows Media and forward it to native format broadcast server 331, such as Windows Media Services, which will then distribute the Windows Media to plurality of Windows Media compatible devices.

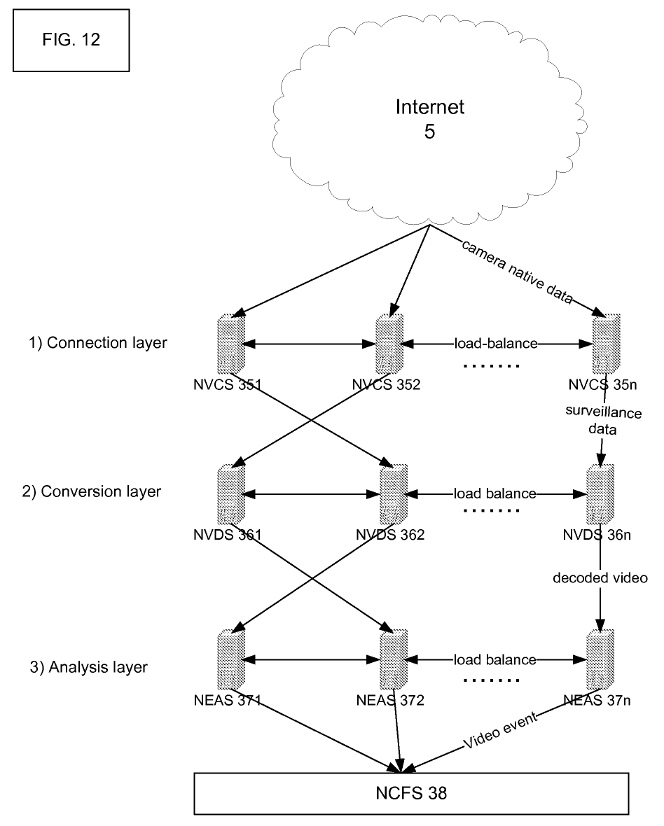

FIG. 12 shows a schematic view of distributed, fully redundant infrastructure architecture with 3 or more role layers, composed from plurality of commodity servers. Each role layer provides full internal redundancy, fail-tolerance and load-balancing, and can withstand failure of multiple composing servers with no reliability impacts. Each layer also transparently supports addition of new composing servers, and removal of existing composing servers, with no impact on ongoing operations.

Each role layer is completely transparent in front of other role layers, including the redundancy, fail-tolerance, load-balancing, and addition and removal operations, and provides a single point of data, media and requests exchange.

The composing servers in each role layer can be geographically distributed, and support the redundancy, fail-tolerance, load balancing and addition and removal operations between themselves.

The Connection role layer is composed from plurality of camera gateway servers 351-35n, which connect over Internet 5 to plurality of cameras. The gateway servers 351-35n connect to cameras and retrieve the surveillance data from them, and forward the surveillance data to the Decoding Role layer.

The gateway servers 351-35n in Connection role layer are continuously monitoring each other via redundancy process. In case one or more of the gateway servers 351-35n fails, the remaining operational servers distribute the cameras of the failed servers among themselves. The cameras are distributed based on current load and network speed, where the least loaded server, with the fastest network connection to the camera, receives the camera.

The gateway servers 351-35n in Connection role layer also periodically optimize their operations based on current load and network speed, where cameras are transferred from the most loaded server or server with a slow network connection to the camera, to the least loaded server, with the fastest network connection to the camera. Addition or removal of gateway servers 351-35n also initiate these optimizations, during which the cameras are transferred to newly added or remaining operational, least loaded servers with the fastest network connections to the cameras.

The Conversion role layer is composed from plurality of unified format conversion servers 361-36n, which receive surveillance data from the Connection role layer. The conversion servers 361-36n convert the surveillance data to unified media format, and forward the unified media to the Analysis role layer.

The conversion servers 361-36n in Conversion role layer are continuously monitoring each other via redundancy process. In case one or more of the conversion servers 361-36n fails, the remaining operational servers distribute the conversion tasks between themselves. The remaining operational servers will request the Connection role layer to re-forward the retrieved surveillance data again, in order to prevent any data loss. The conversion tasks on the re-forwarded surveillance data are distributed based on current load and network speed, where the least loaded server, with the fastest network connection to the Connection role layer, receives the task.

The conversion servers 361-36n in Conversion role layer also periodically optimize their operations based on current load and network speed, where conversion tasks are transferred from the most loaded server or from a server with a slow network connection to the Connection role layer, to the least loaded server, with the fastest network connection to the Connection role layer. Addition or removal of conversion servers 361-36n also initiate these optimizations, during which the conversion tasks are transferred to newly added or remaining operational, least loaded servers with the fastest network connections to the Connection role layer.

The Analysis role layer composed from plurality of analysis servers 371-37n, which receive the unified media from the Conversion role layer, and perform plurality of analysis tasks on the unified media. On predefined results of the analysis tasks, events are created and stored in unified media format on distributed file system (DFS) 38.

The analysis servers 371-37n in Analysis role layer are continuously monitoring each other via redundancy process. In case one or more of the analysis servers 371-37n fails, the remaining operational servers distribute the analysis tasks between themselves. The remaining operational servers will request the Conversion role layer to re-forward again the unified media, in order to prevent any data loss. The analysis tasks on the re-forwarded unified media are distributed based on current load and network speed, where the least loaded server with the fastest network connection to the Conversion role layer, receives the task.

The analysis servers 371-37n in Analysis role layer also periodically optimize their operations based on current load and network speed, where analysis tasks are transferred from the most loaded server or from a server with a slow network connection to the Conversion role layer, to the least loaded server, with the fastest network connection to the Conversion role layer. Addition or removal of analysis servers 371-37n also initiate these optimizations, during which the analysis tasks are transferred to newly added or remaining operational, least loaded servers with the fastest network connections to the Conversion role layer.

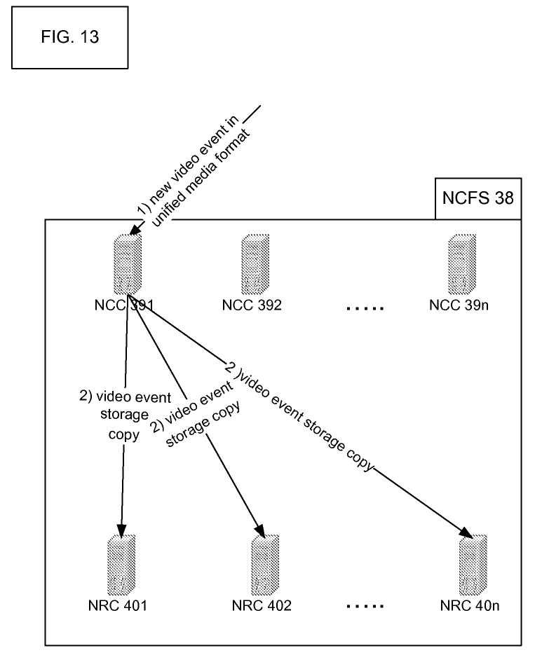

FIG. 13 shows a schematic view of distributed file system (DFS) 38 composed from plurality of commodity servers. The distributed file system 38 receives video events in unified media format from distributed infrastructure, and stores plurality of copies of the video events across the commodity servers, in order to provide complete redundancy and availability of the stored copies.

The distributed file system 38 provides full internal redundancy, fail-tolerance and load-balancing, and can withstand failure of multiple composing servers with no reliability impacts. The distributed file system 38 also transparently supports addition of new composing servers, and removal of existing composing servers, with no impact on ongoing operations.

The distributed file system 38 is completely transparent to distributed infrastructure described in FIG. 12, including the redundancy, fail-tolerance, load-balancing, and addition and removal operations, and provides a single point for storage and retrieval of events and media requests exchange.

The composing servers in distributed file system 38 can be geographically distributed, and support the redundancy, fail-tolerance, load balancing and addition and removal operations between themselves.

The distributed file system 38 is composed from plurality of DFS controller servers 391-39n, and from plurality of DFS recording and storage servers 401-40n. The controller servers 391-39n receive the events in unified media format, and distribute plurality of copies of the events to the recording and storage servers 401-40n. The distribution is based on available disk space, averaged load and network speed, where the recording and storage servers 401-40n with the most available disk space, under the least load on average, and with the fastest network connection to the controller servers 391-39n, receive the event copies.

The controller servers 391-39n are continuously monitoring each other via redundancy process. In case one or more of the controller servers 391-39n fails, the remaining operational servers share the events copies distribution tasks between themselves. The remaining operational servers will request the distributed infrastructure in FIG. 12 to re-forward again the events, in order to prevent any data loss. The distribution tasks on the re-forwarded events are shared based on current load and network speed, where the least loaded server, with the fastest network connection to the distributed infrastructure in FIG. 12, receives the task.

The controller servers 391-39n are also continuously monitoring the recording and storage servers 401-40n via redundancy process. In case one or more of the recording and storage servers 401-40n fails, the controller servers 391-39n distribute the events, which copies were stored on the failed servers, among the operational recording and storage servers 401-40n. The distribution is done in order to maintain an acceptable number of events copies. The distribution is based on available disk space, averaged load and network speed, where the recording and storage servers 401-40n with the most available disk space, under the least load on average, and with the fastest network connection to the controller servers 391-39n, receive the event copies.

Addition or removal of recording and storage servers 401-40n also initiate the events copies distribution, during which the events copies are transferred to newly added or remaining operational servers, with the most available disk space, under the least load on average, and with the fastest network connection to the controller servers.

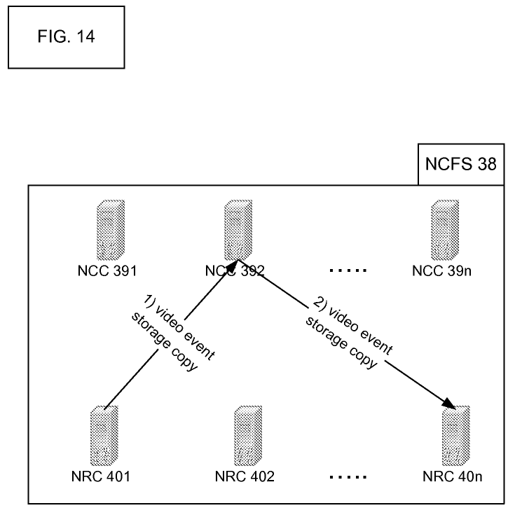

FIG. 14 shows a schematic view of distributed file system (DFS) 38 distribute the events copies in order to maintain an acceptable number of events copies.

The controller servers 391-39n distribute copy of the event among the recording and storage servers 401-40n. The controller servers 391-39n request an event copy from particular source server, selected from the recording and storage servers 401-40n that have the required event copy. The source server is selected based on current load and network speed, where the source server has the least current load, and the fastest network connection to the controller servers 391-39n.

The controller servers 391-39n then distribute the event copy to destination recording and storage server. The destination recording and storage server is selected based on available disk space, averaged load and network speed, where the destination server has the most available disk space, under the least load on average, and with the fastest network connection to the controller servers 391-39n.

The controller servers 391-39n repeat the process with a plurality of other source and destination recording and storage servers, until the acceptable number of events copies is reached.

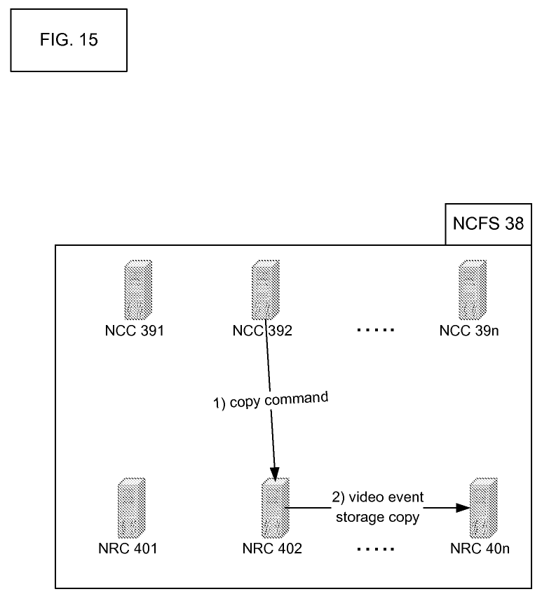

FIG. 15 shows a schematic view of alternative embodiment to FIG. 14, where the controller servers 391-39n send a copy command to selected source recording and storage server, rather then requesting and distributing the event copy as in FIG. 14. The selected source server then copies the event copy directly to another recording and storage server. This approach reduces the load on the controller servers 391-39n, which allows them to perform more operations on recording and storage servers 401-40n. Also, this approach allows a direct communication between the recording and storage servers 401-40n, saving the networks loads between the controller servers 391-39n and recording and storage servers 401-40n.

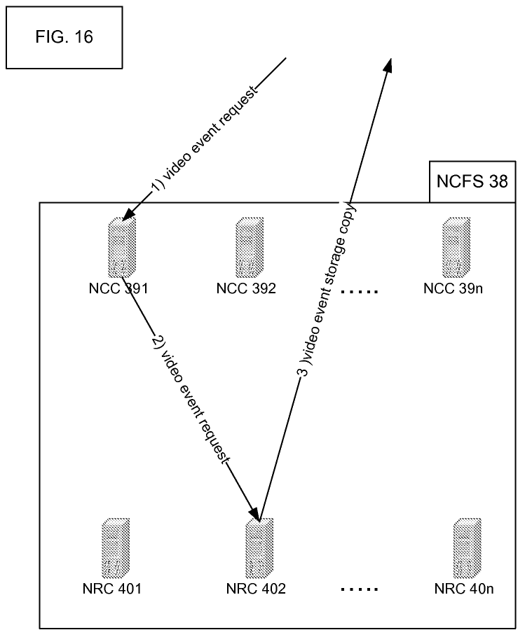

FIG. 16 shows a schematic view of distributed file system (DFS) 38 serving the requests of plurality of requesting entities, for stored events in unified media format.

The controller servers 391-39n receive the requests for events, and locate the serving server from recording and storage servers 401-40n that have the requested event copy. The serving server is located based on current load and network speed, where the serving server has the least current load and the fastest network connection to the requesting entities. The controller servers 391-39n then forward the event request to the serving recording and storage server, which serves the requested media to the requesting entities.

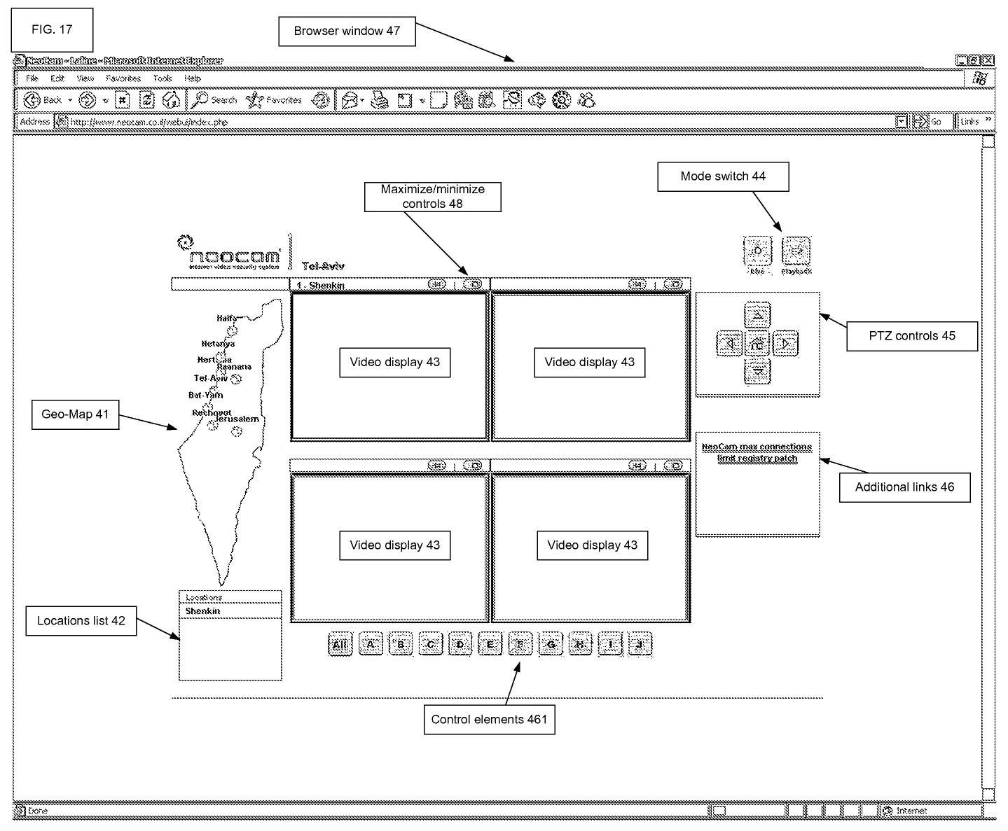

FIG. 17 shows a diagram of web user interface (WUI) which allows a convenient and easy navigation and control of plurality of cameras, and of plurality of recorded events. The web user interface is accessible from any standard Internet browser, and does not require an installation of any external software or plug-in. The users need unique credentials in order to login into the web user interface, and have predefined permissions defining which cameras and recorded events the users are allowed to watch.

The web user interface mode presented in this figure is the view and control mode, which allows an easy navigation in the plurality of cameras, and the view of plurality of surveillance feeds from the cameras. The view and control mode consists of the geographic map 41 listing the cities with cameras, geographic locations 42 listing the city locations with cameras, plurality of video displays 43 showing the surveillance feeds from the cameras, maximize and minimize controls 48 allowing maximizing a particular surveillance feed over the whole screen, and returning back to the normal presentation. The view and control mode also consists of cameras PTZ controls 45, which allow moving, rotating and changing the zoom and focus of cameras, context sensitive controls 461 which perform different operations in different web user interface modes, operation mode switch 44 which switches the web user interface into another operations mode with different purpose and functionality, and aid and utility links section 46, which provide useful tools for download.

For example, in order to navigate and view a particular camera, the user uses the Internet browser window 47 to login with unique credentials into the web user interface. In the view and control mode, the user is presented with geographic map 41, showing cities with cameras he has permissions to view. After the user selects a city, he is presented with the geographic locations 42 showing city locations with cameras he has permissions to view. After selecting a location, the video displays 43 will show all the surveillance feeds from the cameras in the selected locations. The number of displayed video displays 43 will be equal to the number of cameras in the selected location.

The user can use maximize and minimize controls 48 on any video display 43, to maximize a particular surveillance feed over the whole browser window 47. The user can use then maximize and minimize controls 48 again in order to minimize the particular surveillance feed back to the original state of multiple surveillance feeds.

The user can also select a particular surveillance feed and use the cameras PTZ controls 45 to move, rotate and change the zoom and focus of the camera of the particular surveillance feed.

The user can also use the operation mode switch 44 to switch into a different operational mode, use various functionality via the context sensitive controls 461, or download useful tools via the utility links section 46.

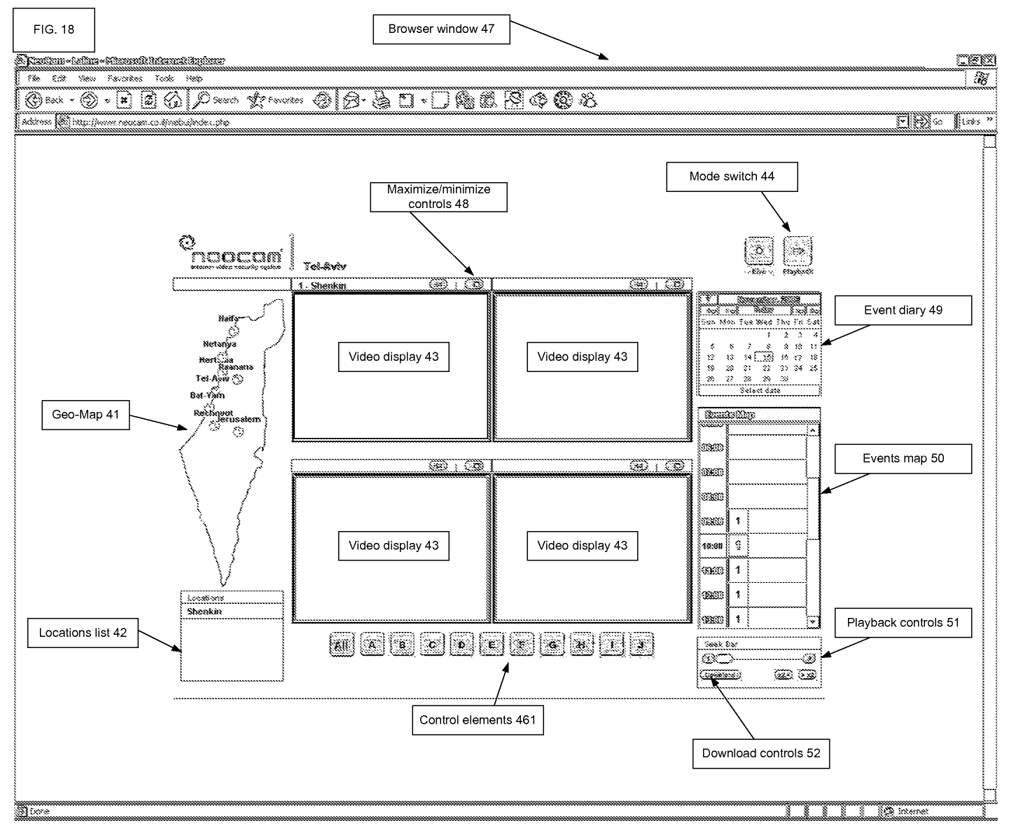

FIG. 18 shows a diagram of playback and media download mode of the web user interface, which is mostly similar to view and control mode presented in FIG. 17. Instead of the cameras PTZ controls 45, and aid and utility links section 46, the playback and media download mode consists of the events diary 49, which allows to select a date of required events to playback, events hourly map 50 that displays the recorded events, rounded to hours, in the selected date, events playback controls 51 which allows to control the playback of the event with plurality of actions, and events media download 52 which allows to download a selected event media.

For example, in order to playback a particular event, the user uses the Internet browser window 47 to login with unique credentials into the web user interface. In the playback and media download mode, the user is presented with geographic map 41, showing cities with cameras he has permissions to view. After the user selects a city, he is presented with the geographic locations 42 showing city locations with cameras he has permissions to view. After selecting a location, the user selects the required date in the events diary 49, and is presented with recorded events, rounded to hours, in events hourly map 50. After the user selects the required event, it will be played back in the video display 43.

If the user will selected the whole hour in the events hourly map 50, rather then a particular event, all of the recorded events for the selected hour will be played back in the video displays 43. The number of video displays 43 will be equal to the number of events in the selected hours.

The user can select a video display 43, and then control the event playback via the events playback controls 51. The user can seek various parts in the event, control the playback speed, and perform other similar actions. The user can also download the event media via the events media download 52.

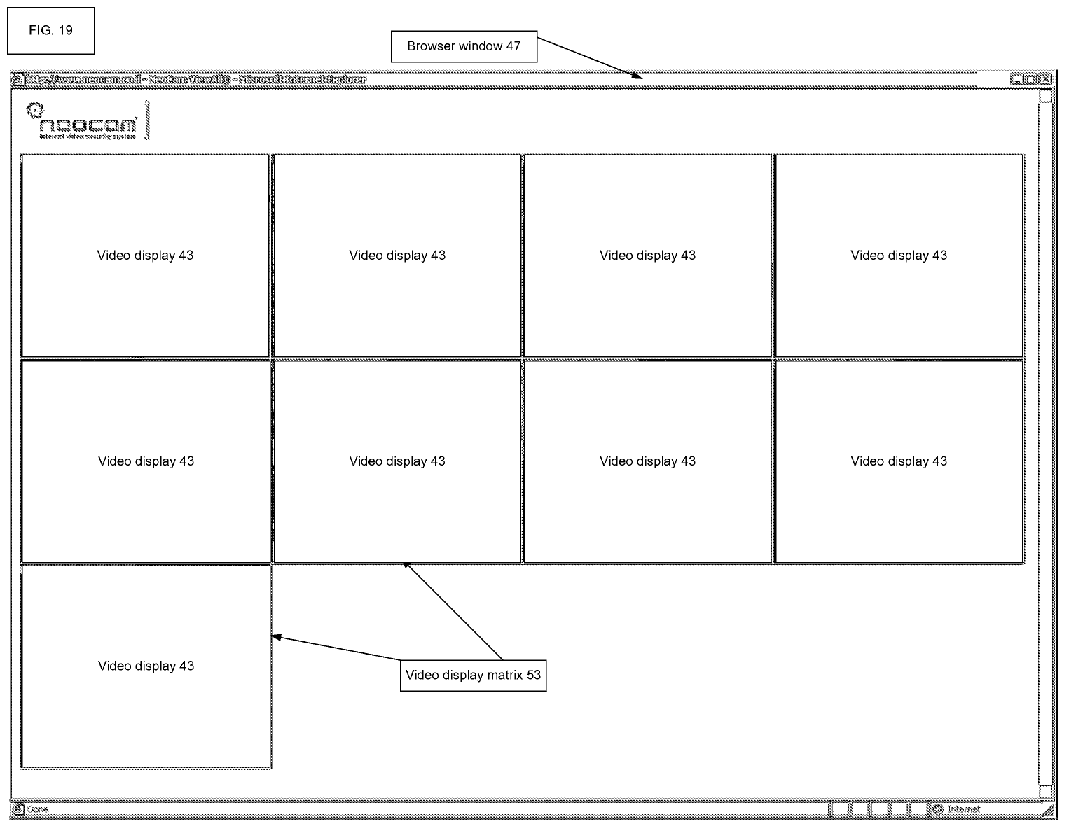

FIG. 19 shows a diagram of surveillance matrix mode of the web user interface, which presents surveillance feeds from plurality of cameras. This mode provides an efficient method to see the surveillance feeds from all of the cameras the user has permissions to watch. The surveillance matrix mode consists of the video display matrix 53, which is composed from plurality of video displays 43.

For example, in order to see all the surveillance feeds the user uses the Internet browser window 47 to login with unique credentials into the web user interface. In the surveillance matrix mode the user will see in the video display matrix 53 surveillance feeds from all the cameras the user has permissions to watch. The video display matrix 53 will be composed from video displays 43, in number equal to the total number of cameras the users has permissions to watch.

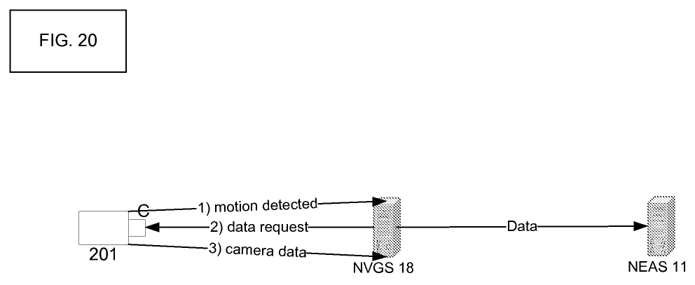

FIG. 20 shows a diagram of camera initiated analysis, in which the camera 201 performs preliminary analysis tasks on the surveillance data, and according to predefined analysis tasks results, notifies the camera media gateway server 18 about the results. The camera media gateway server 18, verifies the results to its own predefined results, then begins to retrieve the surveillance data from the camera 201, converts the surveillance data to unified media format and delivers it to analysis server 11 for further advanced analysis.

For example, the camera 201 analyses the surveillance data for motion detection. When a motion is detected, the camera 201 notifies the camera media gateway server 18 about the motion. The camera media gateway server 18 then verifies if the motion is significant enough, and if it is, begins to retrieve the surveillance data from the camera 201. The camera media gateway server 18 then will convert the retrieved surveillance data to unified media format, and will deliver the unified media to the analysis server 11 for further advanced analysis, such as motion vectors recognition.

The advantages of camera initiated analysis are in lowering the network load, and in lowering the camera media gateway server 18 and analysis server 11 loads. The camera media gateway server 18 retrieves the surveillance data and converts it to unified media format, only when the camera 201 has sufficient results from preliminary analysis. The analysis server 11 performs analysis tasks only when it receives unified media from the camera media gateway server 18, following the camera 201 having sufficient results. The lower loads allow increasing the number of concurrent cameras supported by camera media gateway server 18, and increasing the number of concurrent analysis tasks performed by analysis server 11.

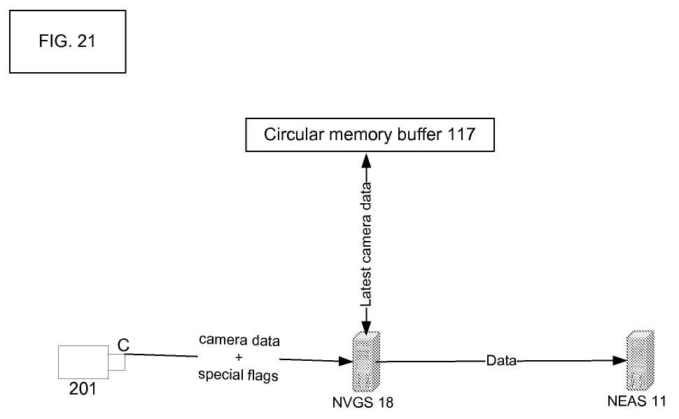

FIG. 21 shows a diagram of alternative embodiment to FIG. 20 is where camera 201 performs preliminary analysis tasks on the surveillance data, and according to predefined analysis tasks results, sets special flags in the surveillance data. The camera media gateway server 18 continuously retrieves the surveillance data, and adds the latest retrieved period of surveillance data to surveillance data circular buffer 117, where the newest retrieved data overwrites the oldest one. The camera media gateway server 18 then checks the surveillance data for special flags and upon their detection, converts the surveillance data stored in circular buffer 117 to unified media format and delivers the unified media to analysis server 11 for further advanced analysis. Afterwards, the camera media gateway server 18 continues retrieving surveillance data from the camera 201, converting it to unified media format and delivering the unified media to analysis server 11 for further advanced analysis.

For example, the camera 201 analyses the surveillance data for motion detection. When a motion is detected, the camera 201 turns on the motion detection flag in the surveillance data. The camera media gateway server 18 is retrieving the surveillance data and stores it in surveillance circular data buffer 117, overwriting the oldest data portion with the newest one. The camera media gateway server 18 then constantly checks the surveillance data for motion detection flags, and when it discovers a motion detection flag turned on, it converts the surveillance data stored in circular buffer 117 to unified media, and delivers the unified media to analysis server 11 for further advanced analysis, such as motion vectors recognition. Afterwards, the camera media gateway server 18 continues converting the retrieved surveillance data to unified media format, and delivering the unified media to the analysis server 11 for further advanced analysis.

The advantage of the alternative embodiment is that it allows the camera media gateway server 18 to interface with preliminary analysis in cameras models that unable to send notifications, but able to set special flags in surveillance data. This allows to lower the load on analysis server 11, and to increase the number of concurrent analysis tasks it can perform. Additional advantage is that the latest surveillance data period, before the moment the special flags were set, is stored in the surveillance circular data buffer 117, which allows including the latest surveillance period for analysis and the subsequent storage with the stored event, which provides a broader view of the event.

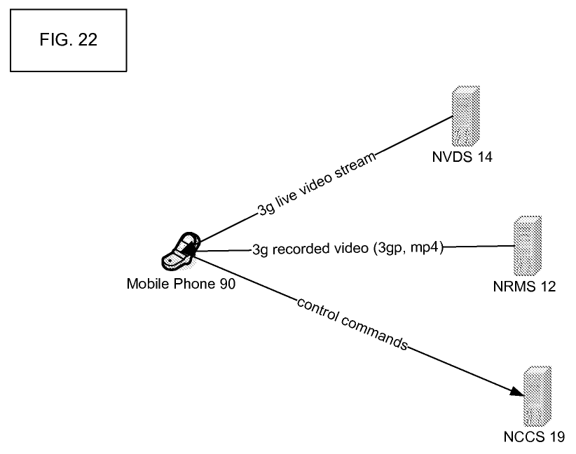

FIG. 22 shows a diagram of 3rd and higher generation mobile phone 90 interacting with invention servers, allowing a mobile user to receive surveillance media and control plurality of cameras.

The mobile user is able via 3rd and higher generation mobile phone 90 to pass authentication with the distribution server 14, retrieve surveillance media from distribution server 14 over media protocol, playback stored media in mobile format from recording server 12, and control plurality of cameras via the command and control server 19.

For example, a user with 3^{rd} generation mobile handset may connect to distribution server 14, and pass authentication with unique credentials. After passing the authentication the user may connect to the distribution server 14 over media protocol such as RTSP, and view surveillance media from the cameras. The user may also connect to the recording server 12 and playback the stored media in mobile format, such as 3 gp. The user is also able to connect to command and control server 19, and move, rotate and change the zoom and focus of the cameras.

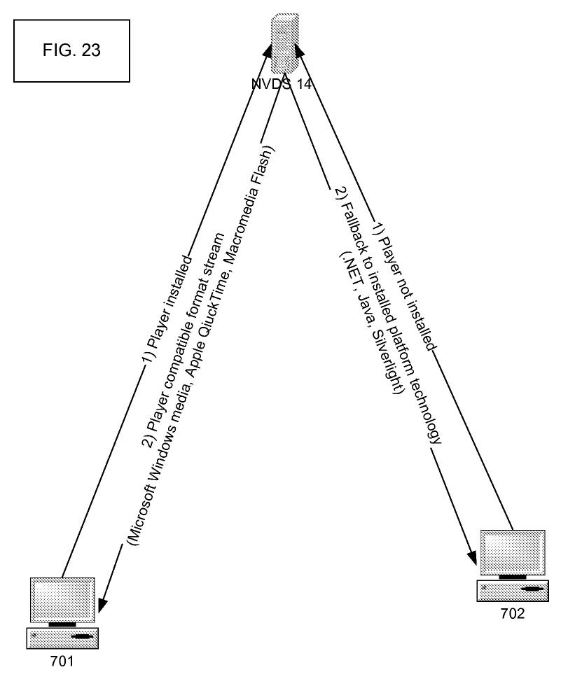

FIG. 23 shows a diagram of installed player detection and fallback to installed technology platform applet, which allows plurality of user computers to display surveillance media and recorded events via players if installed, or via software applets supported by the installed technology platform.

The diagram consists of user computer 701, which has a player installed, and of user computer 702, which does not has a player installed, but has a technology platform installed. The diagram also consists of distribution server 14.

The user computer 701 has an installed player, and will play via the player the surveillance media and stored events from distribution server 14. The user computer 702 does not have an installed player, but has a technology platform installed. The distribution server 14 will detect the installed technology platform, and will deploy to user computer 702 a software applet compatible with the technology platform. The user computer 702 will then play via the deployed software applet the surveillance media and stored events from the distribution server 14.

For example, a user computer 701 which has player installed, such as Windows Media Player or Apple QuickTime, will be able to play via the installed player the surveillance media and stored events from distribution server 14, such as Windows Media Services.

User computer 702 which does not have any player installed, but has technology platform installed such us JAVA, .NET or Silverlight, will have its technology platform recognized by the distribution server 14, which will deploy a software applet suitable for the platform technology. The user computer 701 will then be able to play via the deployed software applet the surveillance media and the stored events from distribution server 14, with no need to install any external player or plug-in.

The advantage of this approach that it allows to support plurality of user computers that does not have any native players installed, using the technology platform installed on them. This relieves the user from the need to install additional software or plug-ins.

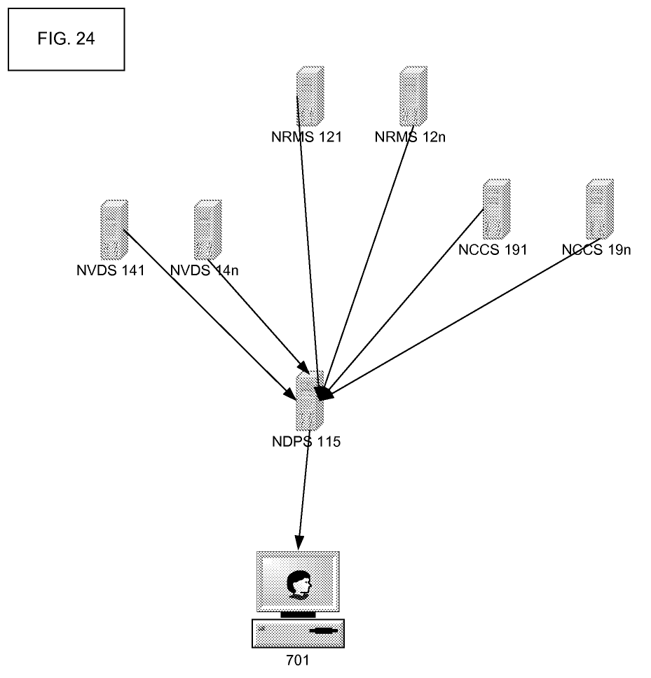

FIG. 24 shows a schematic view of presenting surveillance media and stored events from plurality of cameras in a unified way, and controlling plurality of cameras in a unified way, which consists from plurality of media distribution servers 141-14n, plurality of recording servers 121-121n, plurality of command and control servers 191-19n, central presentation and control server 115, and user computer 701.

The central presentation and control server 115 receives requests for surveillance data from plurality of cameras from user computer 701. The central presentation and control server 115 then retrieves surveillance media from plurality of media distribution servers 141-14n, retrieves stored events from plurality of recording servers 121-121n, and delivers the combined surveillance media and stored events to the user computer 701 in an unified presentation.

The central presentation and control server 115 also receives control commands of plurality of cameras from the user computer 701, and forwards the control commands to plurality of command and control servers 191-19n, which in turn control the plurality of cameras.

The central presentation and control server 115 serves as a single point of presentation and control for the user, allowing easy and convenient access to presentation of surveillance data from plurality of cameras, and control over plurality of cameras.

What is claimed is:

1. A visual surveillance system comprising:
a plurality of operation apparatus retrieving, converting, analyzing, storing and presenting surveillance data, comprising:
analysis server, recording server, messages and notifications server, media distribution server, events information database, events media storage, camera media gateway server, command and control server, central presentation and control server.
Also visual surveillance system comprising:
a plurality of surveillance apparatus generating surveillance data; and
a plurality of presentation apparatus with Internet access;
wherein said operation apparatus retrieving surveillance data from said surveillance apparatus, said operation apparatus analyze and store the surveillance data, said operation apparatuses provide the surveillance data to said presentation apparatus, said operation apparatuses provide notifications to said presentation apparatus, said presentation apparatus control the said surveillance apparatus via the said operation apparatus.

2. A visual surveillance system according to claim 1, interfaces with said surveillance apparatus by detecting plurality of protocols and formats compatible with said surveillance apparatus, and retrieving the said surveillance data using the most efficient protocol and format.

3. A visual surveillance system according to claim 2, converts the said surveillance data to said unified media format.

4. A visual surveillance system according to claim 3, detects the said presentation apparatus presentation capabilities, converts the said unified media format to distribution media format compatible with said presentation apparatus, and distributes the said distribution media to said presentation apparatus.

5. A visual surveillance system according to claim 1, interfaces with said surveillance apparatus by detecting plurality of control protocols compatible with said surveillance apparatus, and enables the said presentation apparatus to control the said surveillance apparatus.

6. A visual surveillance system according to claim 1, shapes the bandwidth of network connection to said surveillance apparatus.

7. A visual surveillance system according to claim 2, bridging between said media distribution server and other said operation apparatus of different operation systems, types and vendors via unified protocol or shared memory, and converting the said unified media format to distribution media format, on said media distribution server or on other said operation apparatus.

8. A visual surveillance system according to claim 2, upon receiving notifications from said surveillance apparatus, begins retrieving the said surveillance data and delivering the said surveillance data to said analysis server.

9. A visual surveillance system according to claim 2, retrieves said surveillance data from said surveillance apparatus and stores the said surveillance data in circular memory buffer, upon detecting special flags in the said surveillance data, delivers the stored surveillance data from said circular memory buffer to said analysis server, and begins retrieving the said surveillance data from said surveillance apparatus and delivering the said surveillance data directly to said analysis server.

10. A visual surveillance system according to claim 5, detects if no means of playback present on said presentation apparatus, detects the present technological means on said presentation apparatus, and delivers to said presentation apparatus component supported by said technological means, having said delivered component provide means of playback.

11. A visual surveillance system according to claim 1, provides means of centralized presentation from plurality of said surveillance apparatus, and centralized control of plurality of said surveillance apparatus, having said presentation and control server provide presentation from plurality of said media distribution servers and from plurality of said recording servers, and having said presentation and control server provide control via plurality of said command and control servers.

12. A distributed infrastructure comprising:
a plurality of distributed operation apparatus retrieving, converting, analyzing surveillance data comprising:
a plurality of camera gateway servers, a plurality of conversion servers; a plurality of analysis servers.
Also distributed infrastructure comprising:
a plurality of storage means; and
a plurality of surveillance apparatus;
wherein said distributed operation apparatus distributes tasks among themselves of: retrieving the surveillance data from said surveillance apparatus, converting the said surveillance data to unified media format, analyzing the said unified media format, and storing the said unified media format on said storage means.

13. A distributed infrastructure according to claim 12, have retrieval tasks of said surveillance data distributed among said camera gateway servers on load-balanced basis, have conversion tasks of said surveillance data to said unified media format distributed among said conversions servers on load-balanced basis, and have analysis tasks of said unified media format distributed among analysis servers on load-balanced basis.

14. A distributed infrastructure according to claim 12, supports addition of new said distributed operation apparatus, and removal of said present distributed operation apparatus, with no impact on ongoing operations.

15. A distributed infrastructure according to claim 14, optimizes the distribution of said retrieval, conversion and analysis tasks, periodically or following addition or removal of said distributed operation apparatus, where said distributed operation apparatus distribute the said retrieval, conversion and analyzing tasks among themselves on load-balanced basis.

16. A distributed file system comprising:
a plurality of distributed storage apparatus comprising:
controller servers, recording and storage servers;
wherein said distributed storage apparatus receives plurality of events in unified media format, distributes plurality of copies of said events among the said distributed storage apparatus, and serve said events copies to plurality of requesting entities.

17. A distributed file system according to claim 16, have said controller servers receiving events in unified media format, have said controller servers allocate the distribution tasks of said events copies among said controller servers on load-balanced basis, have said controller servers distribute said events copies among said recording and storage servers on load-balanced basis, have said controller servers forwarding requests for events from plurality of entities to said recording and storage servers on load-balanced basis, and have said recording and storage servers serve the said requests with said events copies.

18. A distributed file system according to claim 16, supports addition of new said distributed storage apparatus, and removal of present distributed storage apparatus, with no impact on ongoing operations.

19. A distributed file system according to claim 18, maintains certain minimal number of said events copies, following addition or removal of said distributed storage apparatus, having said controller servers duplicate events copies among said recording and storage servers on load-balanced basis, or having said controller servers send duplication commands to said recording and storage servers, which perform the duplication directly among themselves on load-balanced basis.
